(19) United States
(12) Patent Application Publication
(10) Pub. No.: US 2004/0201224 A1
(43) Pub. Date: Oct. 14, 2004

(54) Plug for closing an aperture in a plug receiving member

(76) Inventor: Ezra T. Chang, Scarborough (CA)

Correspondence Address: GOWLING LAFLEUR HENDERSON LLP, LCD 1, 560-120 KING STREET WEST, P.O. BOX 1045, HAMILTON, ON, L8N 3R4, CA

(21) Appl. No.: 10/394,183

(22) Filed: Mar. 24, 2003

(51) Int. Cl. E05C 19/00

(52) U.S. Cl. 292/1

(57) ABSTRACT

A plug for closing an aperture in a plug receiving member has a main body with a screw thread on an end portion thereof operable to cooperate with a screw thread adjacent to the aperture in the plug receiving member to secure the plug thereto in an aperture closing manner, and a series of peripherally spaced laterally resilient fingers extending from the end portion of the main body in a direction away from the main body. The fingers having free end portions remote from the end portion of the main body with laterally outer surfaces shaped to resiliently engage the periphery of the aperture in the plug receiving member to retain the plug in assembly therewith when the plug security means is not engaged with the plug receiving member. The laterally outer surfaces of the fingers are also shaped to resiliently engage the periphery of the aperture in the plug receiving member to retain the plug in an open position whereby liquid can pass through the aperture and between the fingers.

### FIELD OF THE INVENTION

This invention relates to plugs for closing apertures in plug receiving members.

### BACKGROUND OF THE INVENTION

There are circumstances in which it is desired that a plug should not only be prevented from becoming separated from the plug receiving member, but should also be retainable in an open position.

It is therefore an object of the invention to provide an improved plug which fulfills these requirements.

### SUMMARY OF THE INVENTION

According to the invention, a plug for closing an aperture in a plug receiving member has a main body with securing means on an end portion thereof operable to cooperate with complementary means adjacent to the aperture in the plug receiving member to secure the plug thereto in an aperture closing manner. The plug also has a series of peripherally spaced laterally resilient fingers extending from the end portion of the main body in a direction away from the main body. The fingers have free end portions remote from the end portion of the main body with laterally outer surfaces shaped to resiliently engage the periphery of the aperture in the plug receiving member to retain the plug in assembly thereof when the plug securing means is not engaged with the plug receiving member. The laterally outer surfaces of the fingers are also shaped to resiliently engage the periphery of the aperture in the plug receiving member to retain the plug in an open position when the plug securing means is not secured to the plug receiving member whereby liquid can pass through the aperture and between the fingers.

The laterally outer surfaces of the fingers may be shaped to provide step surfaces facing the main body which engage the periphery of the aperture in the plug receiving member to retain the plug in assembly therewith.

The laterally outer surfaces of the fingers may be shaped to provide notches to resiliently engage the periphery of the aperture in the plug receiving member to retain the plug in the open position.

The securing means on the end portion of the main body may comprise a screw thread engagable with a complementary screw thread adjacent to the aperture in the plug receiving member.

A container may have a recessed side wall which can be positioned to face upwardly to enable a liquid to be collected in the recess. The recessed side wall has an aperture receiving a plug in accordance with the invention, whereby liquid collected in the recess can drain therefrom through the aperture into the container when the plug is in an open position.

### DESCRIPTION OF THE DRAWINGS

One embodiment of the invention will now be described, by way of example, with reference to the accompanying drawings, of which:

FIG. 1 is a perspective view of a plug in accordance with one embodiment of the invention,

FIG. 2 is a section view of the plug engaged with a plug receiving member and showing the plug in the open position,

FIG. 3 is a similar view, but showing the plug in a closed position,

FIG. 4 is a perspective view of a container having the plug in a recessed side thereof, the container being shown in an upright position, and

FIG. 5 is a similar view, but showing the container oriented so that the recessed side in which the plug is located is facing upwardly.

### DESCRIPTION OF PREFERRED EMBODIMENT

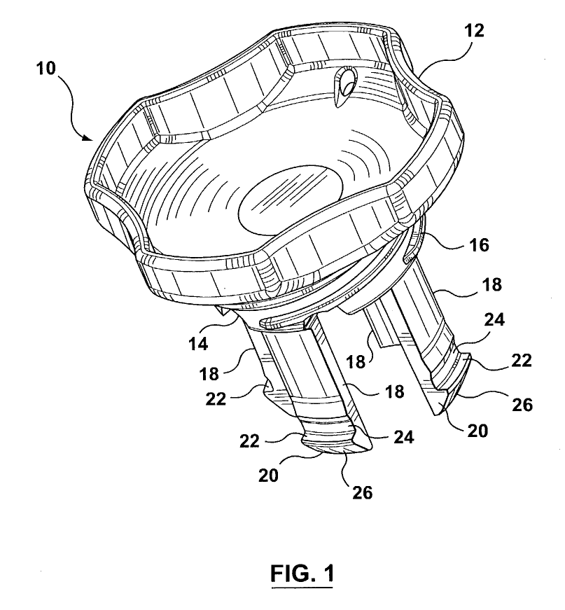

Referring to the drawings, FIG. 1 shows a plug 10 which is a plastic moulding having a main body 12 with a lower end portion 14 provided with an external screw thread 16. The plug 10 also has four peripherally-spaced laterally-resilient fingers 18 extending from the end portion 14 in a direction away from the main body 12. Each finger 18 has a free end portion 20 remote from the body end portion 14 with a laterally outer surface shaped to provide a step surface 22 facing the main body 12 and a notch 24 immediately above the step surface 22. Below the step surface 22, the laterally outer surface of each finger 18 is inclined downwardly and inwardly to provide a ramp surface 26.

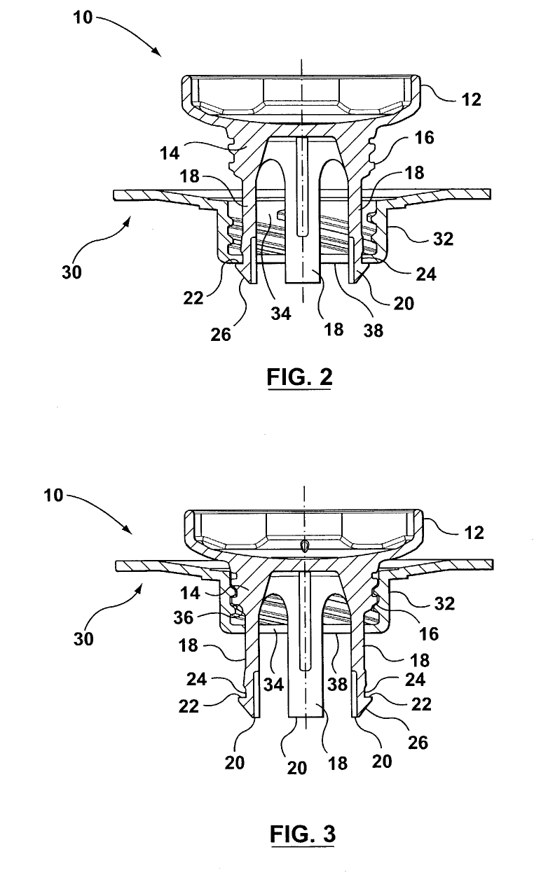

FIG. 2 shows a plug receiving member 30 having a downwardly extending tubular portion 32 forming an aperture 34 and having an internal screw thread 36. The lower end of the tubular portion 32 has a short radially inwardly extending annular finger engaging portion 38. The plug 10 has been engaged with a plug receiving member 30 by snapping the free end portions of the fingers 18 passed the annular finger engaging portion 38 until the finger ramp portions 26 have snapped past the annular finger engaging portion 38 of the plug receiving member 30. The annular finger engaging portion 38 then becomes engaged in the notches 24 of the fingers 18 with the step surfaces 22 of the fingers 18 immediately below the annular finger engaging portion 38 of the plug receiving member 30.

In this position, the plug 10 is held in an open position in which liquid can pass through the aperture 34 and is also retained in assembly with the plug receiving member 30.

To close the aperture 38, the plug 10 is pushed further into the aperture and rotated in a clockwise direction to cause the screw threads 16 of the plug 10 to engage the screw threads 36 of the plug receiving member 30 until the plug 10 reaches the aperture closing position shown in FIG. 3.

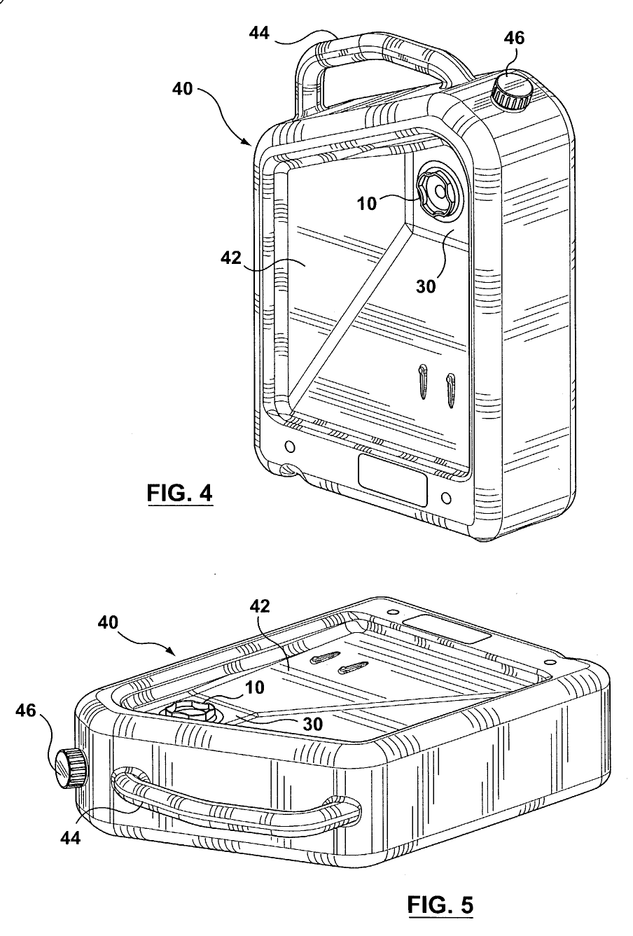

As shown in FIGS. 4 and 5, the plug 10 can be advantageously used with a container 40 which has a recessed side wall 42, the side wall 42 forming the plug receiving member 30. The container 40 has a carrying handle 44 and a conventional outlet closable by a cap 46 which is used when the container 40 is in the upright position shown in FIG. 4.

When the container 40 is laid on its side with the recessed side 42 uppermost as shown in FIG. 5, the container 40 can be positioned so that the recessed side 42 receives oil being drained from a vehicle engine. During such an operation, the plug 10 will be in the position shown in FIG. 2 so that oil collected by the recessed side 42 can pass through the aperture 38 into the interior of the container 40. It will be noted that, if the oil drain plug from the engine is accidentally dropped into the recessed 42, the fingers 18 will prevent it passing through the aperture 38 and falling into the container 40. When the oil draining operation is complete, the plug 10 can be closed and the container 40 carried away for subsequent disposal of the oil in the usual way after removal of the cap 46.

Thus, the plug 10 is very conveniently automatically retained in the open position when required and is also retained in assembly with the container 40 so that it cannot be misplaced.

Other advantages and embodiments of the invention will now be readily apparent to a person skilled in the art. The scope of the invention being defined in the appended claims.

1. A plug for closing an aperture in a plug receiving member,
said plug having a main body with securing means on an end portion thereof operable to cooperate with complementary means adjacent to the aperture in the plug receiving member to secure the plug thereto in an aperture closing manner, and
a series of peripherally spaced laterally resilient fingers extending from the end portion of the main body in a direction away from the main body,
said fingers having free end portions remote from the end portion of the main body with laterally outer surfaces shaped to resiliently engage the periphery of the aperture in the plug receiving member to retain the plug in assembly therewith when the plug securing means is not engaged with the plug receiving member,
the laterally outer surfaces of the fingers also being shaped to resiliently engage the periphery of the aperture in the plug receiving member to retain the plug in an open position when the plug securing means is not secured to the plug receiving member, whereby liquid can pass through the aperture and between the fingers.

2. A plug according to claim 1 wherein the laterally outer surfaces of the fingers are shaped to provide step surfaces facing the main body which engage the periphery of the aperture in the plug receiving member to retain the plug in assembly therewith.

3. A plug according to claim 1 wherein the laterally outer surfaces of the fingers are shaped to provide notches to resiliently engage the periphery of the aperture in the plug receiving member to retain the plug in the open position.

4. A plug according to claim 1 wherein the securing means on the end portion of the main body comprises a screw thread engagable with a complementary screw thread adjacent to the aperture in the plug receiving member.

5. A container having a recessed side wall which can be positioned to face upwardly to enable a liquid to be collected in the recess, said recessed side wall having an aperture receiving a plug in accordance with claim 1, whereby liquid collected in the recess can drain therefrom through the aperture into the container when the plug is in the open position.
